(19) United States
(12) Patent Application Publication
(10) Pub. No.: US 2013/0191781 A1
(43) Pub. Date: Jul. 25, 2013

(54) DISPLAYING AND INTERACTING WITH TOUCH CONTEXTUAL USER INTERFACE

(71) Applicants: Samuel Chow Radakovitz, Puyallup, WA (US); Clinton Dee Covington, Redmond, WA (US)

(72) Inventors: Samuel Chow Radakovitz, Puyallup, WA (US); Clinton Dee Covington, Redmond, WA (US)

(73) Assignee: MICROSOFT CORPORATION, Redmond, WA (US)

(21) Appl. No.: 13/355,193

(22) Filed: Jan. 20, 2012

(51) Int. Cl. G06F 3/048

(52) U.S. Cl. 715/810

(57) ABSTRACT

When a user uses touch to interact with an application, a contextual touch user interface (UI) element may be displayed that includes a display of commands that are arranged in sections on a tool panel that appears to float over an area of the display. The sections include a C/C/P/D section, an object specific section and may include a contextual trigger/section and an additional UI trigger. The C/C/P/D section may comprise one or more of: cut, copy, paste and delete commands. The object specific section displays commands relating to a current user interaction with an application. The contextual trigger/section displays contextual commands and the alternative trigger section displays another UI element comprising more commands when triggered.

### BACKGROUND

Many computing devices (e.g. smart phones, tablets, laptops, desktops) allow the use touch input and hardware based input (e.g. mouse, pen, trackball). Using touch input with applications that are designed for hardware based input can be challenging. For example, some interactions associated with hardware based input may not function properly with touch input.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

When a user uses touch to interact with an application, a contextual touch user interface (UI) element may be displayed that includes a display of commands that are arranged in sections on a tool panel that appears to float over an area of the display. The sections include a C/C/P/D section, an object specific section and may include a contextual trigger/section and an additional UI trigger. The C/C/P/D section may comprise one or more of: cut, copy, paste and delete commands. The object specific section displays commands relating to a current user interaction with an application. The contextual trigger/section displays contextual commands and the alternative trigger section displays another UI element comprising more commands when triggered.

### BRIEF DESCRIPTION OF THE DRAWINGS

FIG. 1 illustrates an exemplary computing environment;

FIG. 2 illustrates an exemplary system for displaying and interacting with a touch user interface element;

FIG. 3 shows an illustrative processes for displaying and interacting with a touch contextual user interface;

FIG. 4 shows a system architecture used in displaying and interacting with a touch UI element;

FIGS. 5-10 illustrate exemplary displays showing touch user interface elements; and

FIG. 11 illustrates an exemplary sizing table that may be used in determining a size of UI elements.

### DETAILED DESCRIPTION

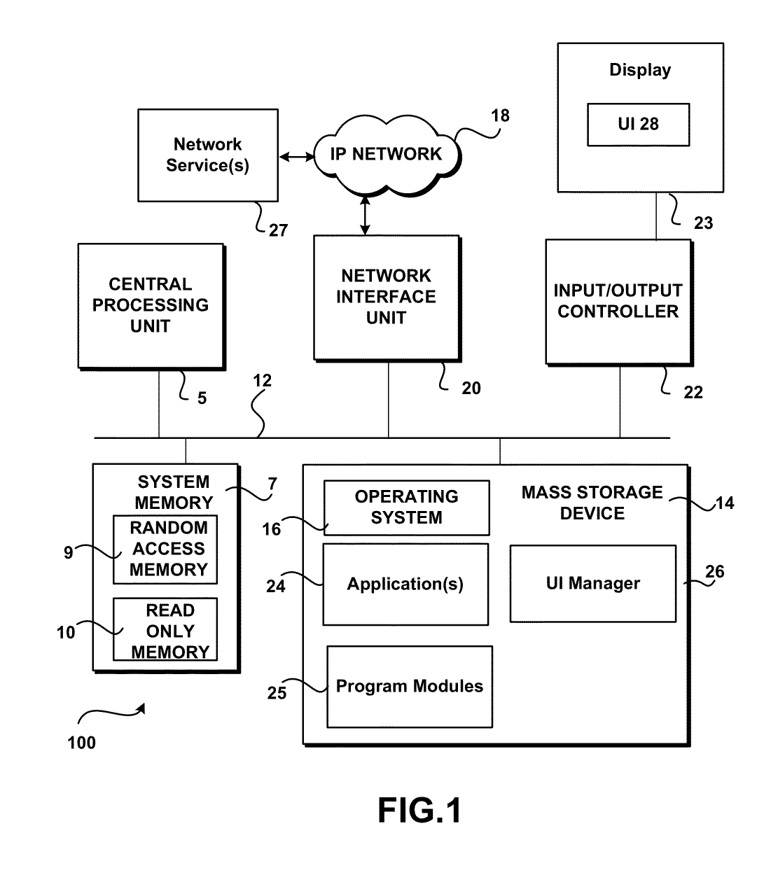

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, netbook, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24 (e.g. productivity application, Web Browser, and the like), program modules 25 and UI manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, a touch input device, or electronic stylus (not shown in FIG. 1). Similarly, an input/output controller 22 may provide input/output to a display screen 23, a printer, or other type of output device.

A touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display. The input/output controller 22 may also provide output to one or more display screens 23, a printer, or other type of input/output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a computer, such as the WINDOWS 8®, WINDOWS PHONE 7®, WINDOWS 7®, or WINDOWS SERVER® operating system from MICROSOFT CORPORATION of Redmond, Wash. The mass storage device 14 and RAM 9 may also store one or more program modules. In particular, the mass storage device 14 and the RAM 9 may store one or more application programs, such as a spreadsheet application, word processing application and/or other applications. According to an embodiment, the MICROSOFT OFFICE suite of applications is included. The application(s) may be client based and/or web based. For example, a network service 27 may be used, such as: MICROSOFT WINDOWS LIVE, MICROSOFT OFFICE 365 or some other network based service.

UI manager 26 is configured to display and perform operations relating to a touch user interface (UI) element that includes a display of commands that are arranged in sections on a tool panel that appears to float over an area of the display. The sections comprise touch sections including a C/C/P/D section and a contextual section that may include a trigger to display contextual commands and a trigger to display another UI element. The C/C/P/D section may comprise one or more of: cut, copy, paste and delete commands. The touch UI element also includes an object specific section that displays commands relating to a current user interaction with an application change between an input mode that includes a touch input mode and a hardware based input mode.

The input mode may be entered and exited automatically and/or manually. When the touch input mode is entered, user interface (UI) elements are optimized for touch input. When the touch input mode is exited, the user interface (UI) elements are optimized for hardware based input. A user may enter the touch input mode by manually selecting a user interface element and/or by entering touch input. Settings may be configured that specify conditions upon which the touch input mode is entered/exited. For example, the touch input mode may be configured to be automatically entered upon undocking a computing device, receiving touch input when in the hardware based input mode, and the like. Similarly, the touch input mode may be configured to be automatically exited upon docking a computing device, receiving hardware based input when in the touch input mode, and the like.

The user interface elements (e.g. UI 28) that are displayed are based on the input mode. For example, a user may sometimes interact with application 24 using touch input and in other situations use hardware based input to interact with the application. In response to changing the input mode to a touch input mode, UI manager 26 displays a user interface element optimized for touch input. For example, touch UI elements may be displayed: using formatting configured for touch input (e.g. changing a size, spacing); using a layout configured for touch input; displaying more/fewer options; changing/removing hover actions, and the like. When the input mode is changed to the hardware based input mode, the UI manager 26 displays UI elements for the application that are optimized for the hardware based input. For example, formatting configured for hardware based input may be used (e.g. hover based input may be used, text may be displayed smaller), more/fewer options displayed, and the like.

UI manager 26 may be located externally from an application, e.g. a productivity application or some other application, as shown or may be a part of an application. Further, all/some of the functionality provided by UI manager 26 may be located internally/externally from an application. More details regarding the UI manager are disclosed below.

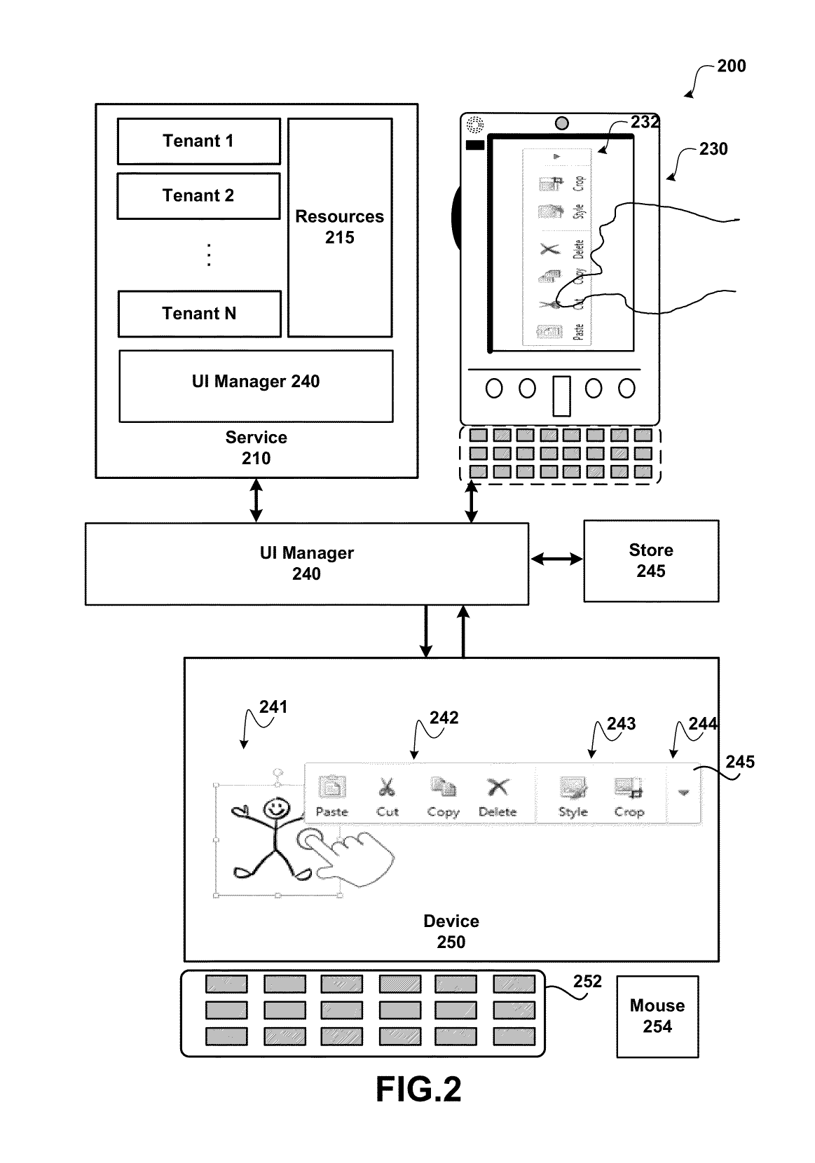

FIG. 2 illustrates an exemplary system for displaying and interacting with a touch user interface element. As illustrated, system 200 includes service 210, UI manager 240, store 245, device 250 (e.g. desktop computer, tablet) and smart phone 230.

As illustrated, service 210 is a cloud based and/or enterprise based service that may be configured to provide productivity services (e.g. MICROSOFT OFFICE 365 or some other cloud based/online service that is used to interact with items (e.g. spreadsheets, documents, charts, and the like). Functionality of one or more of the services/applications provided by service 210 may also be configured as a client based application. For example, a client device may include an application that performs operations in response to receiving touch input and/or hardware based input. Although system 200 shows a productivity service, other services/applications may be configured to select items. As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/smart phone 230 that detects when a touch input has been received (e.g. a finger touching or nearly touching the touch screen) and device 250 that may support touch input and/or hardware based input such as a mouse, keyboard, and the like. As illustrated, device 250 is a computing device that includes a touch screen that may be attached/detached to keyboard 252, mouse 254 and/or other hardware based input devices.

Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Content (e.g. documents, files, UI definitions . . . ) may be stored on a device (e.g. smart phone 230, device 250 and/or at some other location (e.g. network store 245).

As illustrated, touch screen input device/smart phone 230 shows an exemplary display 232 of a touch UI element including a C/C/P/D section, an object specific section, and a contextual section. The touch UI element is configured for touch input. Device 250 shows a display of a selected object 241 in which a touch UI element including C/C/P/D section 242, an object specific section 243 relating to interacting with object 241, and a contextual section 244 that when selected displays a menu of touch selectable options.

UI manager 240 is configured to display differently configured user interface elements for an application based on whether an input mode is set to touch input or the input mode is set to a hardware based input mode.

As illustrated on device 250, a user may switch between a docking mode and an undocked mode. For example, when in the docked mode, hardware based input may be used to interact with device 250 since keyboard 252 and mouse 254 are coupled to computing device 250. When in the undocked mode, touch input may be used to interact with device 250. A user may also switch between the touch input mode and the hardware based input mode when device 250 is in the docked mode.

The following is an example for illustrative purposes that is not intended to be limiting. Suppose that a user has a tablet computing device (e.g. device 250). While working from their desk, the user generally uses mouse 254 and keyboard 252 and leaves computing device 250 docked. The user may occasionally reach out to touch the monitor to scroll or adjust a displayed item, but the majority of the input while device 250 is docked is hardware based input using the mouse and keyboard. UI manager 240 is configured to determine the input mode (touch/hardware) and to display the UI elements (e.g. 232, 245) for touch when the user is interacting in the touch mode and to display the UI elements for hardware based input when the user is interacting using the hardware based input mode. The UI manager 240 may be part of the application the user is interacting with and/or separate from the application.

The input mode may be switched automatically/manually. For example, a user may select a UI element (e.g. UI 240) to enter/exit touch mode. When the user enters the touch mode, UI manager 240 displays the UI elements that are optimized for touch input. The input mode may be switched automatically in response to a type of detected input. For example, UI manager 240 may switch from the hardware based input mode to touch input mode when touch input is received (e.g. a user's finger, hand) and may switch from the touch input mode to the hardware based input mode when a hardware based input, such as mouse input, docking event, is received. According to an embodiment, UI manager 240 disregards keyboard input and does not change the input mode from the touch input mode to a hardware based input mode in response to receiving keyboard input. According to another embodiment, UI manager 240 changes the input mode from the touch input mode to a hardware based input mode in response to receiving keyboard input. A user may disable the automatic switching of the modes. For example, a user may select a UI element to enable/disable the automatic switching of the input mode.

When the user undocks the computing device, UI manager may automatically switch the computing device to touch input mode since device 250 is no longer docked to the keyboard and mouse. In response to switching the input mode to touch, UI manager 240 displays UI elements for the application that are adjusted for receiving the touch input. For example, menus (e.g. a ribbon), icons, and the like are sized larger as compared to when using hardware based input such that the UI elements are more touchable (e.g. can be selected more easily). UI elements may be displayed with more spacing, options in the menu may have their style changed, and some applications may adjust the layout of touch UI elements. In the current example, it can be seen that the menu items displayed when using hardware based input (display 262) are sized smaller and arranged horizontally as compared to touch based UI elements 232 that are sized larger and are spaced farther apart. Additional information may also be displayed next to the icon when in touch mode (e.g. 232) as compared to when receiving input using hardware based input. For example, when in hardware based input mode, hovering over an icon may display a “tooltip” that provides additional information about the UI element that is currently being hovered over. When in touch mode, the “tooltips” (e.g. “Keep Source Formatting”, “Merge Formatting”, and “Values Only”) are displayed along with the display of the icon.

After re-docking device 250, the user may manually turn off the touch input mode and/or touch input mode may be automatically switched to the hardware based input mode.

According to an embodiment, the UI elements change in response to a last input method by a user. A last input type flag may be used to store the last input received. The input may be touch input or hardware based input. For example, the touch input may be a user's finger(s) or hand(s) and the hardware based input is a hardware device used for input such a mouse, trackball, pen, and the like. According to an embodiment, a pen is considered a touch input instead of a hardware based input (as configured by default). When a user clicks with a mouse, the last input type flag is set to “hardware” and when the user taps with a finger, the last input type flag is set to “touch.” While an application is running different pieces of UI adjust as they get triggered in based on the value of the last input type flag. The value of the last input type flag may also be queried by one or more different applications. The application(s) may use this information to determine when to display UI elements configured for touch and when to display UI elements configured for hardware based input.

In the current example, the touch UI element 245 is a UI element configured for touch input (e.g. spacing/sizing/options different from UI element configured for hardware input). The UI element appears to “float” over an area of the display (e.g. a portion of object 24. The UI element is typically displayed near a current user interaction.

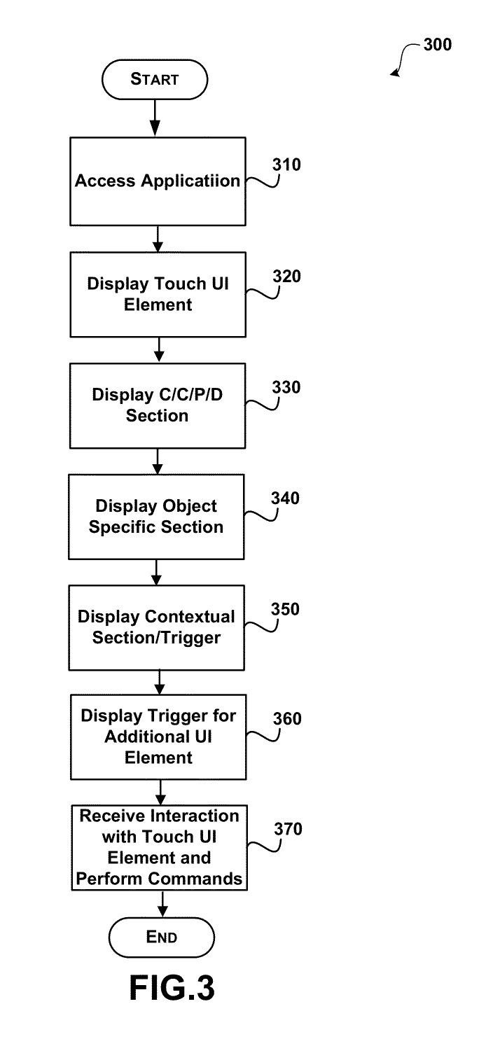

FIG. 3 shows an illustrative processes for displaying and interacting with a touch contextual user interface. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the ordering of the operations may change and be performed in other orderings.

After a start operation, process 300 moves to operation 310, where a user accesses an application. The application may be an operating environment, a client based application, a web based application, a hybrid application that uses both client functionality and/or network based functionality. The application may include any functionality that may be accessed using touch input and hardware based input.

Moving to operation 320, the touch UI element is displayed. According to an embodiment, the touch UI element includes contextual commands that are associated with a current user interaction with an application. For example, a user may select an object (e.g. picture, word(s), calendar item, . . . ) and in response to the selection related options to interact with the object are displayed within the touch UI element.

The touch UI element includes a C/C/P/D section that displays commands relating to cut, copy, paste and delete operations, an object specific section that displays commands relating to a current user interaction with an application, and may include a contextual trigger that displays contextual commands in response to a touch input and an additional UI trigger that when triggered displays a different UI element that includes more commands related to the user interaction.

The touch UI element is configured to receive touch input but may receive touch input and/or hardware based input. For example, the touch input may be a user's finger(s) or hand(s). According to an embodiment, touch input may be defined to include one or more hardware input devices, such as a pen. The input may also be a selection of a UI element to change the input mode and/or to enable/disable automatic switching of modes.

Transitioning to operation 330, the C/C/P/D section of the touch UI element is displayed that displays commands relating to cut, copy, paste and delete operations. According to an embodiment, the C/C/P/D section is displayed at the beginning of the UI element. The C/C/P/D section, however, may displayed at other locations within the UI element (e.g. middle, end, second from end, and the like). One or more commands that relate to cut, copy, paste and delete are displayed. For example, a paste command, a cut command and a copy command may be displayed. A copy command and a delete command may be displayed. A paste command, a cut command, a copy command and a delete command may be displayed. A cut command and a copy command may be displayed. A paste command may be displayed. A delete command may be displayed. Other combinations may also be displayed. According to an embodiment, the commands that are displayed in the C/C/P/D section are determined based on a current selection (e.g. text, cell, object . . . ).

Flowing to operation 340, the commands in the object specific section are displayed in the touch UI element. The commands displayed in the object specific section are determined by the current application and context. The object specific commands may be arranged in different ways. For example, the commands may be displayed in one or two lines. Generally, the commands that are displayed in the object specific section are a small subset (e.g. 1-4 or more) of the available commands.

Moving to operation 350, the contextual section/trigger is displayed within the UI element. Some applications may display a portion of the contextual commands directly within the UI element. Other applications may display a trigger that when selected displays the related contextual commands. According to an embodiment, the contextual selection/trigger is displayed when a right click menu (e.g. a contextual menu) is associated with a hardware based input UI element. According to an embodiment, any contextual commands that are already displayed on the touch UI element are not displayed in the contextual menu when triggered.

Transitioning to operation 360, a trigger for an additional UI element may be displayed. For example, the trigger may invoke a ribbon UI that displays a primary UI for interacting with the application. According to an embodiment, the additional UI is displayed near a top of the display. The additional UI may be displayed at other locations (e.g. side, bottom, user determined location). Selecting the additional UI trigger may result in the touch UI element being hidden and/or remaining visible. For example, tapping on the trigger may hide the touch UI element and show a ribbon tab specified by the application. When the ribbon tab is already displayed, tapping on the trigger displays an indicator showing that the ribbon tab is already displayed. According to an embodiment, the additional UI trigger is displayed at the far right of the touch UI element.

Flowing to operation 370, a user may interact with the touch UI element. In response to a selection, the associated command is performed. According to an embodiment, when a hardware based input mode is entered, the contextual trigger and the C/C/P/D section are removed from the display of the touch UI element and the touch UI element is optimized for hardware based input.

The process then flows to an end block and returns to processing other actions.

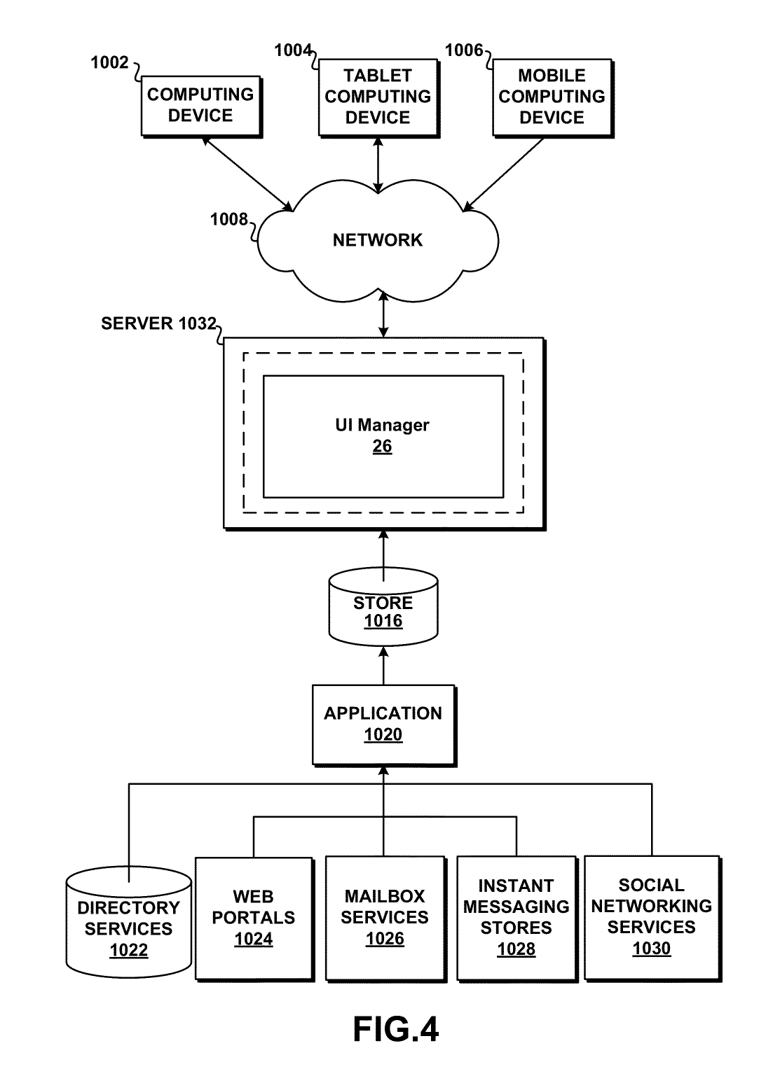

FIG. 4 shows a system architecture used in displaying and interacting with a touch UI element, as described herein. Content used and displayed by the application (e.g. application 1020) and the UI manager 26 may be stored at different locations. For example, application 1020 may use/store data using directory services 1022, web portals 1024, mailbox services 1026, instant messaging stores 1028 and social networking sites 1030. The application 1020 may use any of these types of systems or the like. A server 1032 may be used to access sources and to prepare and display electronic items. For example, server 1032 may access UI elements for application 1020 to display at a client (e.g. a browser or some other window). As one example, server 1032 may be a web server configured to provide productivity services (e.g. word processing, spreadsheet, presentation . . . ) to one or more users. Server 1032 may use the web to interact with clients through a network 1008. Server 1032 may also comprise an application program. Examples of clients that may interact with server 1032 and an application include computing device 1002, which may include any general purpose personal computer, a tablet computing device 1004 and/or mobile computing device 1006 which may include smart phones. Any of these devices may obtain content from the store 1016.

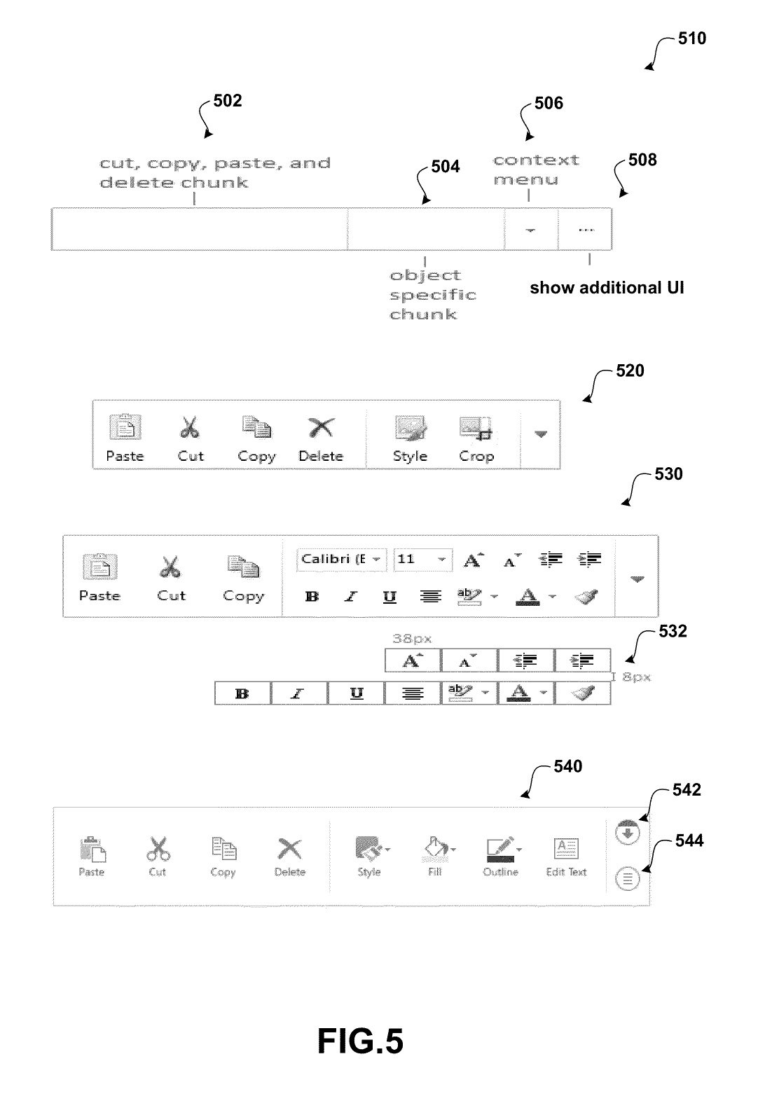

FIGS. 5-10 illustrate exemplary displays showing touch user interface elements. FIGS. 5-10 are for exemplary purpose and are not intended to be limiting.

FIG. 5 illustrates a touch UI element that presents commands arranged in sections on a tool panel that appears to float over an area of the display near a current user interaction.

Display 510 shows exemplary sections of a touch UI element that includes a C/C/P/D section 502 that displays commands relating to cut, copy, paste and delete operations, an object specific section 504 that displays commands relating to a current user interaction with an application, a contextual trigger 506 that displays contextual commands in response to a touch input and an additional UI trigger 508 that when triggered displays a different UI element that includes more commands related to the user interaction then are displayed on the touch UI element 510.

Display 520 shows a touch UI element that includes a display of a C/C/P/D section, an object specific section, and a contextual trigger but does not include the display of the additional UI trigger.

Display 530 shows an example of a touch UI element that includes a display of operation arranged in two lines within the object specific section. Display 530 also shows an exemplary spacing of the UI elements configured for touch (e.g. sized at 38px and spaced at 8px). Other spacings/sizings that are configured for touch may be used.

Display 540 shows a touch UI element that includes a display of a C/C/P/D section, an object specific section, and a section that includes a contextual trigger 544 an additional UI trigger 542. The contextual trigger 544 displays a contextual menu including contextual commands when triggered. The different UI element 542 when triggered displays a different UI element that includes more commands related to the user interaction then are displayed on the touch UI element 540. According to an embodiment, triggering different UI element 542 displays a tab of a ribbon user interface element that relates to the object. For example, if touch UI element 540 is displayed in response to touching a picture, then touching different UI element 542 displays more options relating to interacting with a picture (e.g. brightness, contrast, recolor, compress, shadow effects, position, crop, and the like).

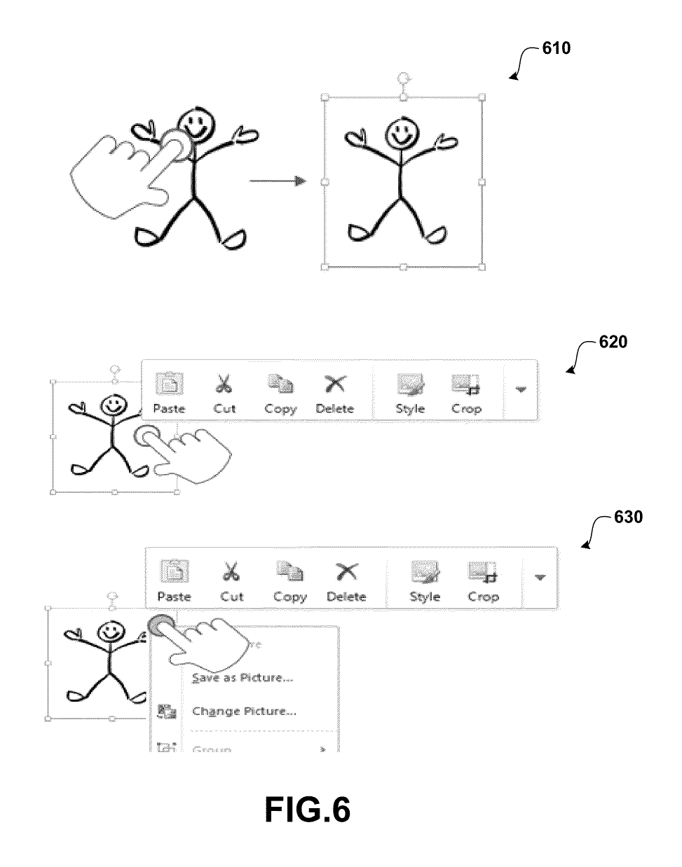

FIG. 6 shows an example for interacting with an object and displaying a touch UI element.

Display 610 shows selecting a picture object.

Display 620 shows displaying a touch UI element 620 in response to tapping the already selected object 610. In response to receiving a tap, UI element 620 is shown that includes the different sections configured for touch input. According to another embodiment, touch UI element 620 may be shown upon the initial selection of the object.

Display 630 shows triggering the contextual trigger of the touch UI element. The contextual commands may be triggered by tapping the trigger and/or by pressing and holding a position for a predetermined period of time.

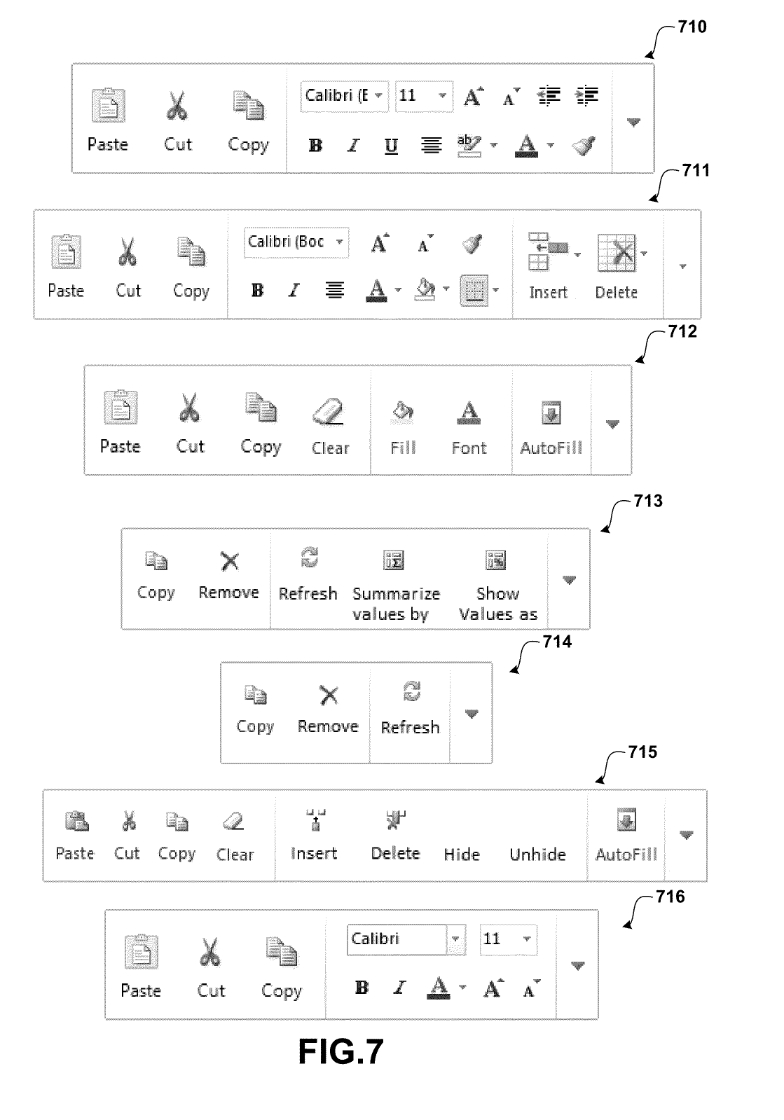

FIG. 7 illustrates exemplary touch UI elements for use with different applications.

Displays 710-716 show different touch UI elements for use with different applications such as word processing and spreadsheet applications.

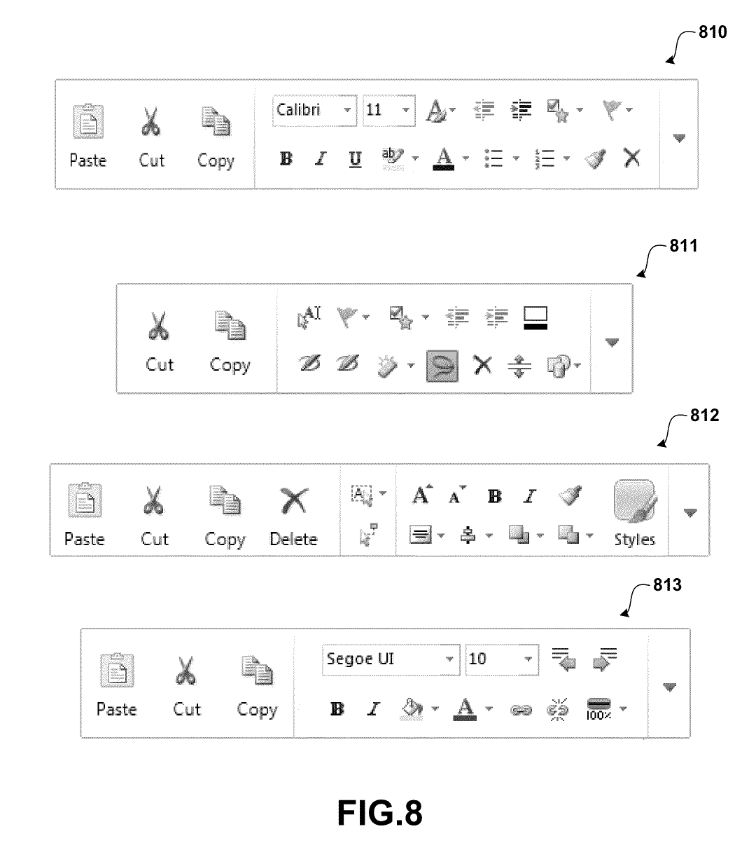

FIG. 8 shows exemplary touch UI elements for use with different applications.

Displays 810-813 show different touch UI elements for use with different applications such as note taking and graphics applications.

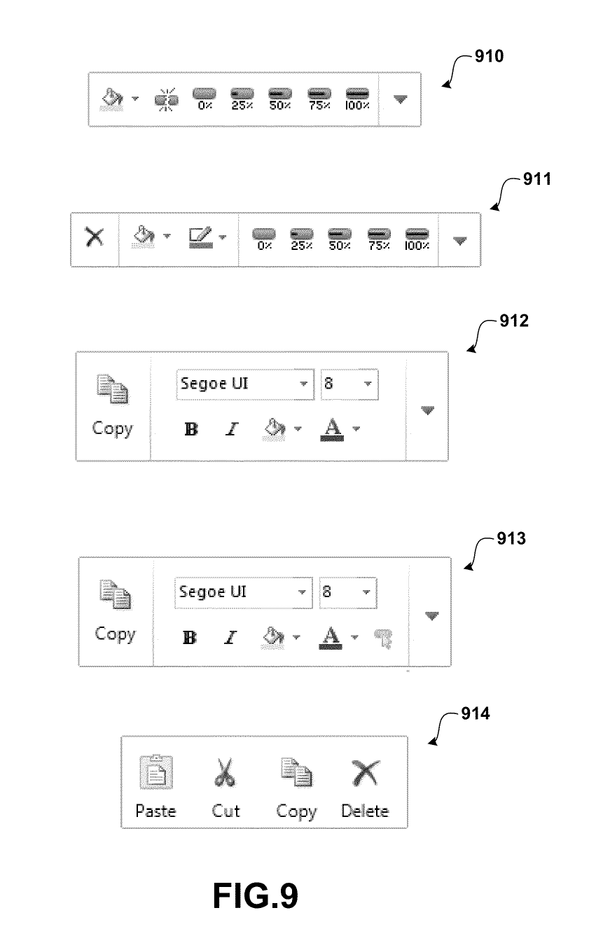

FIG. 9 illustrates exemplary touch UI elements for use with different applications.

Displays 910-914 show different touch UI elements for use with different applications such project applications.

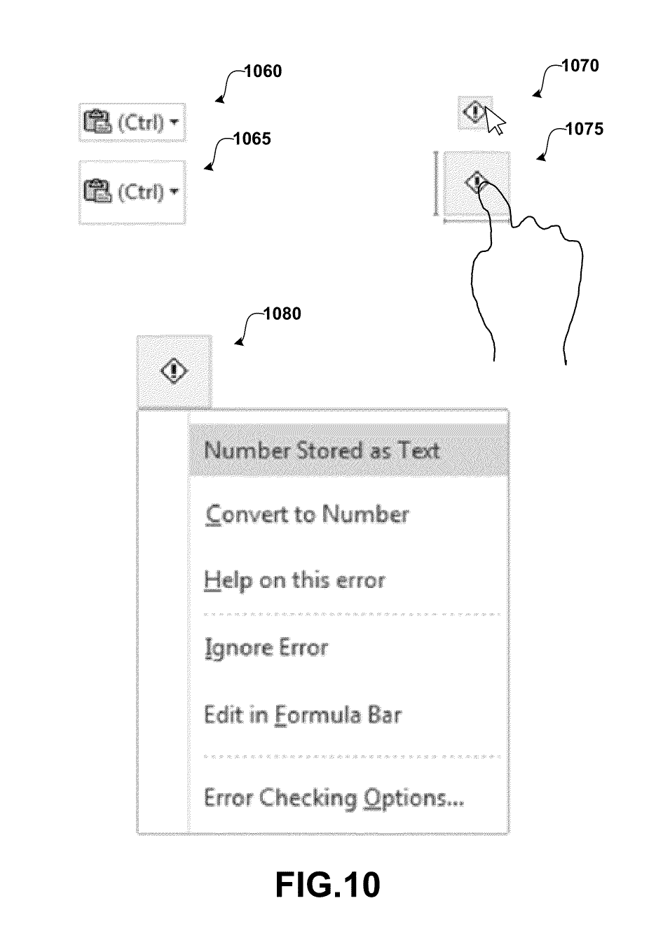

FIG. 10 shows UI elements sized for hardware based input and UI elements sized for touch input.

Hardware based input UI elements (e.g. 1060, 1070) are displayed smaller than corresponding touch input UI elements (e.g. 1065, 1075).

Display 1080 shows selection of touch based UI element 1075. The spacing of the menu option is display 1080 are farther apart as compared to a corresponding hardware based input menu.

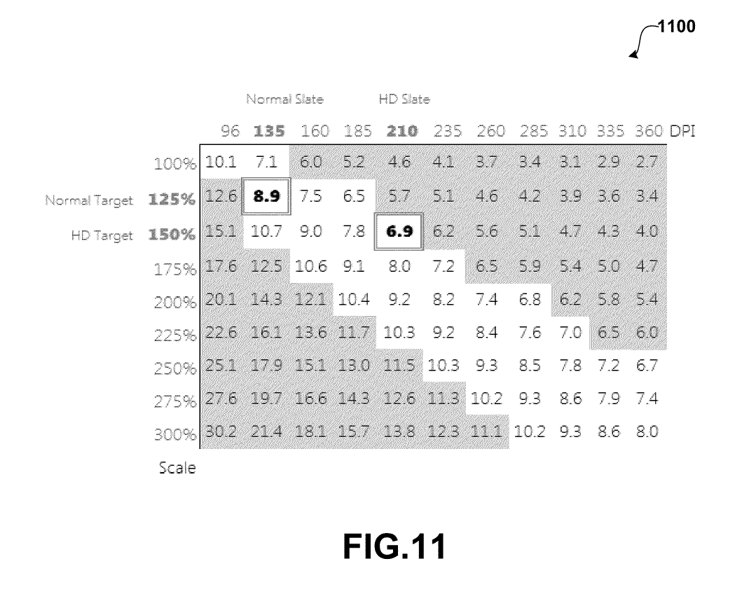

FIG. 11 illustrates an exemplary sizing table that may be used in determining a size of UI elements.

Table 1100 shows exemplary selections for setting a size of UI elements that are configured for touch. According to an embodiment, a target size of 9 mm is selected with a minimum size of 6.5 mm. Other target sizes may be selected.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for displaying a touch contextual User Interface (UI), comprising:
displaying a touch UI element that presents commands arranged in sections on a tool panel that appears to float over an area of the display, wherein the sections comprise a C/C/P/D section that displays commands relating to cut, copy, paste and delete operations, an object specific section that displays commands relating to a current user interaction with an application, and a contextual trigger that displays contextual commands in response to a touch input;
receiving touch input that selects an operation displayed on the touch UI element; and
performing the operation.

2. The method of claim 1, wherein the C/C/P/D section comprises a display of a cut command, a copy command and a paste command.

3. The method of claim 2, wherein the C/C/P/D section comprises a display of a delete command.

4. The method of claim 2, wherein the object specific section comprises a display of commands that are defined by an application relating to the current user interaction.

5. The method of claim 1, further comprising displaying an additional UI option to show a different UI element at a different location from the touch UI element that displays more commands relating to the current user interaction.

6. The method of claim 1, further comprising hiding the display of the UI element and displaying the different UI element specified by the application in response to a selection of the additional UI option.

7. The method of claim 1, further comprising limiting a number of the commands in the object specific section to less than five.

8. The method of claim 1, wherein the touch UI element is replaced by a UI element that is configured for hardware based input in response to an input mode switching from a touch input mode to a hardware based input mode.

9. The method of claim 8, further comprising removing the display of the C/C/P/D section and the contextual section when the input mode is the hardware based input mode.

10. A computer-readable medium storing computer-executable instructions for displaying touch contextual User Interface (UI), comprising:
displaying a touch UI element in response to an interaction with a document that presents commands arranged in sections on a tool panel that appears to float over an area of the display, wherein the sections comprise a C/C/P/D section that displays one or more commands relating to cut, copy, paste and delete operations, an object specific section that displays commands relating to a current user interaction with an application, and a contextual trigger that displays contextual commands when triggered;
receiving touch input that selects an operation displayed on the touch UI element; and
performing the operation.

11. The computer-readable medium of claim 10, wherein the C/C/P/D section comprises a display of at least two of: a cut command, a copy command, a paste command, and a delete command.

12. The computer-readable medium of claim 10, further comprising displaying an additional UI option to show a different UI element at a top of a display of a document from the touch UI element that displays more commands relating to the current user interaction with the application.

13. The computer-readable medium of claim 10, further comprising hiding the display of the UI element and displaying the different UI element specified by the application in response to a selection of the additional UI option.

14. The computer-readable medium of claim 10, further comprising limiting a number of the commands in the object specific section to less than five.

15. The computer-readable medium of claim 10, wherein the touch UI element is replaced by a UI element that is configured for hardware based input in response to an input mode switching from a touch input mode to a hardware based input mode.

16. The computer-readable medium of claim 10, further comprising removing the display of the C/C/P/D section and the contextual trigger when the input mode is a hardware based input mode.

17. A system for displaying touch contextual User Interface (UI), comprising:
a display that is configured to receive touch input;
a processor and memory;
an operating environment executing using the processor;
an application that includes; and
a UI manager operating in conjunction with the application that is configured to perform actions comprising:
displaying a touch UI element in response to an interaction with a document that presents commands arranged in sections on a tool panel that appears to float over an area of the display, wherein the sections comprise a C/C/P/D section that displays one or more commands relating to cut, copy, paste and delete operations, an object specific section that displays commands relating to a current user interaction with an application, a contextual trigger that displays contextual commands when triggered, and an additional UI trigger that shows a different UI element at a top of a display of the document that displays more commands relating to the current user interaction with the application;
receiving touch input that selects an operation displayed on the touch UI element; and
performing the operation.

18. The system of claim 17, further comprising hiding the display of the touch UI element and displaying the different UI element specified by the application in response to a selection of the additional UI option.

19. The system of claim 17, wherein the touch UI element is replaced by a UI element that is configured for hardware based input in response to an input mode switching from a touch input mode to a hardware based input mode.

20. The system of claim 17, further comprising removing the display of the C/C/P/D section and the contextual trigger when the input mode is a hardware based input mode.
